(19) United States
(12) Patent Application Publication
(10) Pub. No.: US 2015/0088837 A1
(43) Pub. Date: Mar. 26, 2015

(54) RESPONDING TO SERVICE LEVEL OBJECTIVES DURING DEDUPLICATION

(71) Applicant: NetApp, Inc., Sunnyvale, CA (US)

(72) Inventors: Giridhar Appaji Nag, Yasa, Bangalore (IN); Atish Kathpal, Bangalore (IN)

(21) Appl. No.: 14/032,860

(22) Filed: Sep. 20, 2013

(51) Int. Cl. G06F 17/30

(52) U.S. Cl. CPC G06F 17/30371; G06F 17/30312
USPC 707/692

(57) ABSTRACT

Technology is described for responding to service level objectives during deduplication. In various embodiments, the technology receives a service level objective (SLO); receives data to be stored at the data storage system; computes an amount of deduplication to apply to the received data responsive to the SLO; deduplicates the data to the computed amount; and stores the deduplicated data. The deduplicated data may be stored in such a manner that the data can be read in a manner that meets the SLO.

### BACKGROUND

Data storage systems (“storage systems”) comprise multiple computing devices and storage devices (e.g., hard disk drives, optical disk drives, solid state drives, tape drives, etc.) The storage systems can store large amounts of data across multiple computing devices and storage devices to enable high availability, resilience to hardware or other failures, etc. Generally speaking, storage systems can be classified according to their latency and/or throughput. For example, a high speed storage system may use very fast hard disk drives, solid state drives (SSDs), caching, etc., to maximize throughput and minimize latency. However, employing these storage devices can be very expensive for storing large amounts of data. A low speed storage system may employ other media types (e.g., slower hard disk drives, hard disk drives that conserve energy by powering down, tape drives, optical drives, etc.) to reduce costs, but provide lower throughput and higher latency. An example of an existing high speed storage system is a filer commercialized by NetApp, Inc., who is the assignee of the instant application. An example of a low speed storage system is a Glacier service provided by Amazon, Inc.

Users of storage systems sometimes specify service level objectives regarding performance, e.g., latency or throughput of data. A service level objective (SLO) can be part of an agreement, e.g., between an administrator of a storage system and users of the storage system. The users may specify SLOs based on their expected utilization of storage services, e.g., depending on which applications they commonly use. For example, a database application or a web application may require immediate access to a lot of data and so its owner (“user”) may specify an SLO with high throughput and low latency, and incur any concomitant additional expense. On the other hand, a backup and restore application may require much slower data access speeds for reading and/or writing data and so its owner may specify an SLO with low throughput and high latency to minimize costs.

To reduce the amount of data they store, storage systems sometimes employ deduplication technology. Deduplication is a compression technique for reducing or eliminating duplicate copies of data. As an example, when two files or objects share some common data, deduplication may store the common data only once. In some implementations, repeating “chunks” of data may be replaced with a small reference to the location where the repeated data is stored. This compression technique can be used to improve storage utilization and reduce network bandwidth usage.

### BRIEF DESCRIPTION OF THE DRAWINGS

FIG. 1 is a flow diagram illustrating a routine invoked by the technology in various embodiments to store data.

FIG. 2 is a block diagram illustrating an environment in which the disclosed technology may operate in various embodiments.

FIG. 3 is a flow diagram illustrating a routine invoked by the disclosed technology in various embodiments to store data.

FIG. 4 is a block diagram illustrating components employed by the disclosed technology in various embodiments.

FIG. 5 is a schematic diagram illustrating a portion of a media element, e.g., the tape cartridge, to store deduplicated data.

FIG. 6 is a block diagram illustrating grouping of media elements consistent with various embodiments.

FIG. 7 is a directed acyclic graph illustrating identification of cliques.

FIG. 8 is a flow diagram illustrating a routine invoked by the disclosed technology in various embodiments to group objects for storage in media elements based on an analysis of a directed acyclic graph.

### DETAILED DESCRIPTION

Technology is described for enabling and responding to service level objectives (SLOs) relating to low speed storage systems, e.g., when applying deduplication (“the technology”). In various embodiments, the technology receives one or more SLOs and applies deduplication in a manner that is responsive to the received SLOs. The SLOs can be specified in terms of capacity, throughput, write policy, access pattern, and latency. Capacity relates to the amount of data to be stored. Throughput relates to the average rate of data to be transferred between a computing device that employs the low speed data storage system (“host”) and the low speed data storage system. Write policy relates to whether data can be rewritten. Access pattern relates to how the data is read. Latency relates to a time delay between receiving a command or operation and responding thereto. The technology then determines how to apply deduplication, e.g., to achieve the SLOs.

In storage systems that employ multiple slow data storage devices and/or media (e.g., tape cartridges or optical disks), deduplication can be applied to data stored on a single media element (e.g., tape cartridge or optical disk) or across multiple media elements. Changing media elements can increase latency considerably. For example, when deduplication is applied across several tape cartridges (also referred to as simply “tapes”), storage utility may be maximized. However, data stored on a first tape cartridge may be referenced as part of a deduplication process applied to a second tape cartridge. As a result, when a file from the second tape cartridge is read and the file references (e.g., because of deduplication) data stored on the first tape cartridge, the tape drive must stop reading data from the second tape cartridge and then start reading data from the first tape cartridge. This change process can considerably increase latency and reduce throughput, e.g., because tape cartridges may need to be removed, inserted, wound to the correct point on the tape, etc. On the other hand, if deduplication is only applied on a per-media-element level, storage utility could be lower, but latency and throughput issues are improved. It may be possible to take into consideration the number of available data storage devices to determine how many media elements can be used during deduplication. As an example, if a tape drive can read from four tapes concurrently, deduplication may be applied across three tape cartridges. How many media elements to apply deduplication across can be a function of the SLO.

In various embodiments, the technology first stores and deduplicates data and then makes a replica of the deduplicated data. To increase data availability (“reliability”), storage systems may employ replicas. For example, to reduce the possibility of data loss, a low speed data storage system may store data redundantly across multiple media elements to create replicas. The technology may determine that some data stored across replicas should not be deduplicated because doing so would reduce data availability. In various embodiments, a tape drive can utilize up to 50 tape cartridges and a “tape plex” can be a group comprising a specified number of the tape cartridges. Thus, a tape drive can house multiple tape plexes. Replicas may be stored in two different tape plexes. Accordingly, deduplication may be applied within tape plexes. For example, if two replicas are each stored on 6 tape cartridges (for a total of 12 tape cartridges), deduplication may be applied within each of the two 6-tape groups, but not across all 12 tape cartridges. In some embodiments, tape plexes may span across tape drives, e.g., so that a tape plex has more tape cartridges than the maximum number of tape cartridges utilized by a tape drive. To store the replica, the technology may select a tape plex, e.g., by identifying an optimal tape plex for the replica.

In various embodiments, the technology can apply “window deduplication” to reduce a “shoeshine effect.” When a tape drive reads from a tape cartridge, it “races” at a high speed to a point on the tape at which the data is expected to exist. If the tape drive has overshot the location, it then rewinds the tape at a slower speed to locate the data more precisely. After locating and reading the data, the tape drive may then race again to the next location, and likely overshoot that as well. This back and forth tape motion is known as the shoeshine effect. Because the shoeshine effect results in decreased throughput (and reduction in tape life), reducing the effect is desirable. To reduce the shoeshine effect, the technology divides a media element (e.g., a tape cartridge) into a set of N partitions. The technology then applies the depulication within a “window” of K partitions, wherein K is less than or equal to N. During deduplication, the technology may only compress data (e.g., by adding a reference to previously stored data) stored in the previous K partitions (e.g., within a window).

Some data storage systems can employ various techniques to store data mostly contiguously. Users may even employ various tools to lay data out contiguously. These steps are commonly undertaken to reduce latency that is caused when data is not stored contiguously, e.g., seek time to locate disk tracks. As an example, NetApp's filers employ a WAFL® can initially store data contiguously when contiguous space is available. When the data is deduplicated, contiguity of the data may be reduced because the references to previously stored data may refer to data stored on widely dispersed tracks, platters, and indeed hard disk drives (e.g., hard disk drives associated with different RAID groups or even computing devices). The technology can apply window deduplication to hard disk drives, e.g., by restricting deduplication to a specified number of tracks, platters, etc. As an example, the technology may use a “window” of a specified number of adjacent or nearby tracks. The technology may then only deduplicate data within the specified number adjacent or nearby tracks, e.g., so that reading deduplicated data (and reconstruction of that data) that is widely dispersed in a hard disk drive does not exceed a specified SLO.

Although the technology is described with reference to using tape cartridges, the technology can equally be applied to usage of optical disks, hard disk drives (e.g., that can enter a low-power state when not in use), etc. Some hard disk drives can have various power states from powered off, sleep/standby, low speed mode, and high speed mode. In a manner akin to changing tape cartridges, latency and throughput can be affected based on which power state a hard disk drive is in when data is written to (or read from) it and which power state is required. As an example, if the hard disk drive is in a sleep or standby mode and data is to be read quickly, the hard disk drive may take time to change power modes. The technology is capable of controlling the power states of one or more hard disk drives, e.g., responsive to specified SLOs.

In various embodiments, deduplication may be either fixed length or variable length. As an example, when a hash value is computed for data, the data can have a specified size (or “length”) or may have variable length. This size may be adjusted, e.g., at configuration time or runtime in response to received SLOs.

The technology can also be applied to high speed storage systems, e.g., to improve throughput of applications that access data sequentially (e.g., long streams of data). Also, the technology can be applied to file storage, object storage, or indeed any other type of data storage. Thus, files and objects may be discussed interchangeably herein.

Several embodiments of the described technology are described in more detail in reference to the Figures. The computing devices on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can comprise computer-readable storage media (e.g., “non-transitory” media) and computer-readable transmission media.

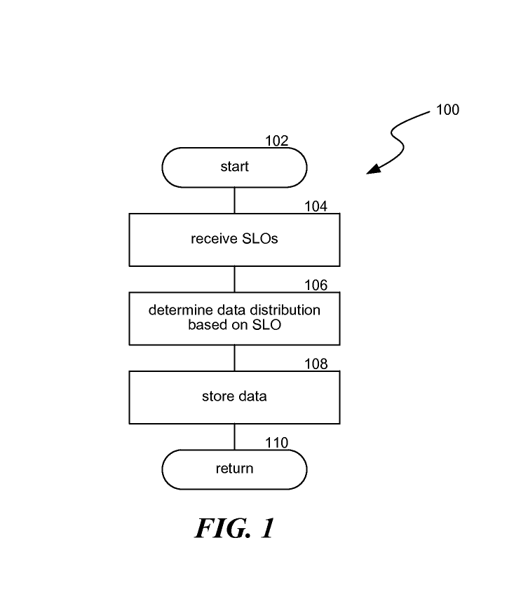

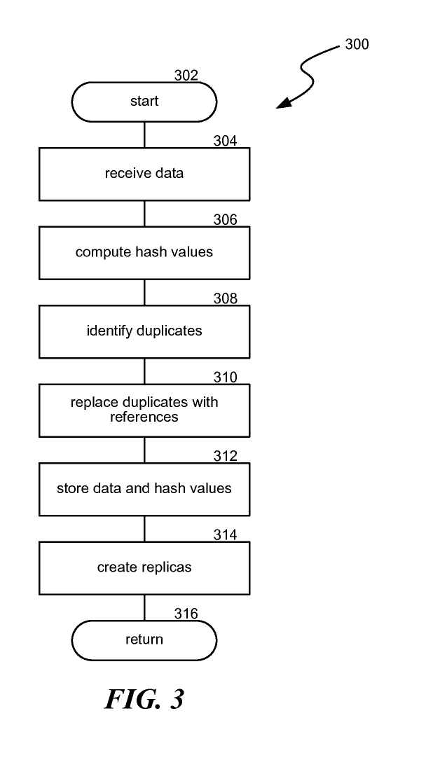

Turning now to the Figures, FIG. 1 is a flow diagram illustrating a routine 100 invoked by the technology in various embodiments to store data. The routine begins at block 102. At block 104, the routine receives one or more SLOs. As examples, the routine may receive an indication that throughput is to be maximized, latency is to be minimized, etc. Alternatively, the routine may receive an indication of a type of application that is employing the storage system and may determine SLOs based on the identified application. The technology can receive the SLOs as a document (e.g., an XML document), as parameters to an application program interface method, via a user interface, etc. At block 106, the routine processes the received SLO and determines how to distribute data based on the received SLOs, how to deduplicate the data, etc. As examples, the routine may determine that the data is to be distributed across multiple media elements, a single media element, etc. To process the received SLO, the technology may compare specified parameters (e.g., application type, desired throughput, desired latency, etc.) to previously stored values, e.g., in a table associating values to configuration parameters. The technology can then apply the configuration parameters or request a system administrator to configure the storage system in a manner that would cause the storage system to conform with the received SLOs. At block 108, the routine then stores the received data. Further details relating to how the data is to be stored are described below in relation to FIG. 3. The routine returns at block 110.

Those skilled in the art will appreciate that the logic illustrated in FIG. 1 and described above, and in each of the flow diagrams discussed below, may be altered in various ways. For example, the order of the logic may be rearranged, substeps may be performed in parallel, illustrated logic may be omitted, other logic may be included, etc. The term “logic”, as used herein, can include, for example, special-purpose hardwired circuitry, software and/or firmware in conjunction with programmable circuitry, or a combination thereof.

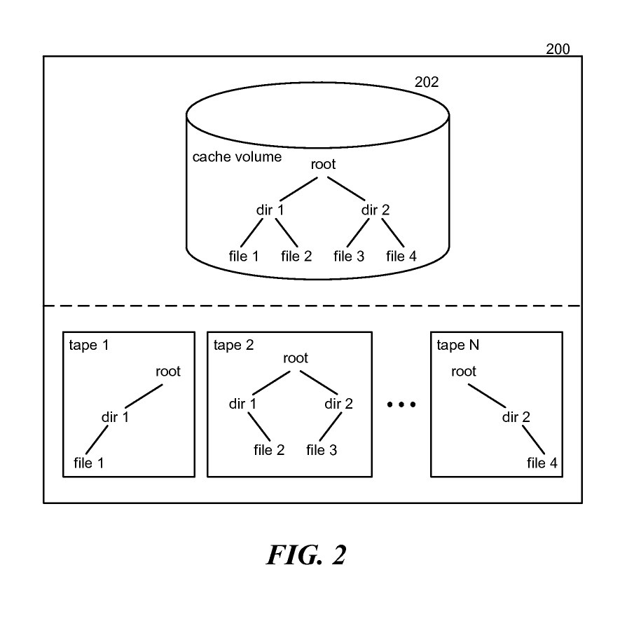

FIG. 2 is a block diagram illustrating an environment 200 in which the disclosed technology may operate in various embodiments. The environment 200 can include a cache value 202 and one or more media elements, e.g., tape cartridges 204a, 204b, and 204n. In various embodiments, the environment 200 can operate on one or multiple computing devices. As an example, the cache volume 202 can be a database stored on a hard disk drive in the same computing device that operates tape drives or a separate device that is connected, e.g., via a network or other data communications technology. The cache volume 202 can store information relating to how data (e.g., files, objects, etc.) is stored, e.g., in the media elements. As an example, the cache volume 202 can store metadata information corresponding to the stored data. The cache volume may also temporarily store data, e.g., so that computing devices do not need to wait for tape operations to be completed. In the illustrated embodiment, cache volume 202 stores an entire file system, whereas each of the media elements stores a portion of the data corresponding to the file system.

In some embodiments, the cache volume may be resizeable at runtime to respond to SLOs. As an example, the cache volume may be a portion of a hard disk drive or solid state drive that is allocated for use during storage operations on media elements (e.g., tape cartridges). In other embodiments, the cache volume may be statically allocated during deployment, e.g., to respond to known SLOs.

FIG. 3 is a flow diagram illustrating a routine invoked by the disclosed technology in various embodiments to store data. The routine 300 begins at block 302. At block 304, the routine receives data to be stored in the storage system. At block 306, the routine computes hash values for the received data. In various embodiments, the routine may use various techniques for computing hash values. The computed hash values (or other identifications) can be used to deduplicate data by first checking to see whether other data has already been stored that has the same hash value and, if not, storing the data. If other data has been stored with the same hash value, a duplicate may have been identified. Any technique generally known in the art for identifying duplicates can be used. Further details relating to NetApp's deduplication technology that may be employed in some embodiments are described in U.S. Pat. No. 8,321,648. At block 308, duplicates are identified using one or more of these prior art techniques. At block 310, duplicate data is replaced with references to the previously stored data. As an example, if a duplicate is identified, a reference is stored, e.g., to a portion of a previously stored file or object. At block 312, once the data has been deduplicated, the data and the hash values are stored in the storage system. At block 314, after the data is stored, replicas are created. As discussed in further detail below, the replicas may be stored in media elements other than the media elements in which the data is originally stored at block 312. The routine then returns at block 316.

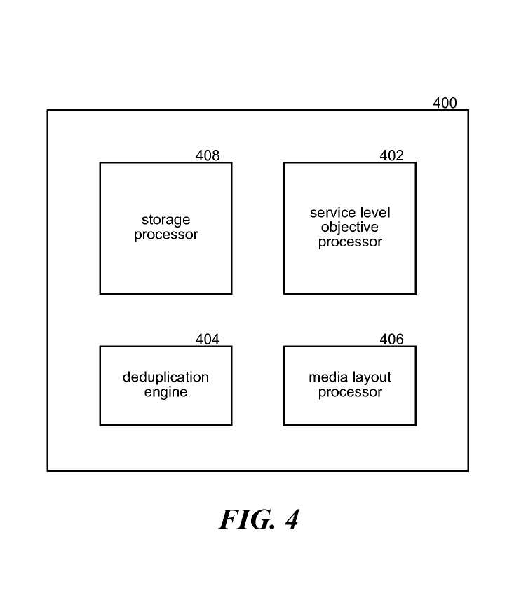

FIG. 4 is a block diagram illustrating components 400 employed by the disclosed technology in various embodiments. The components 400 can include a storage processor 408, a service level objective processor 402, a deduplication engine 404, and a media layout processor 406. The service level objective processor 402 can process storage level objectives the technology receives, e.g., to identify how received data should be stored to respond to the service level objectives. As an example, deduplication may be applied across a single media element or a computed number of media elements, e.g., based on the specified service level objectives. The deduplication engine 404 can identify duplicates in the received data, e.g., before the data is stored. The deduplication engine 404 can also reassemble data so that references are resolved to actual data. The media layout processor 406 can translate storage commands to locations on media. As an example, the media layout processor may employ a linear tape filesystem format or a modified version thereof. The storage processor 408 can respond to commands, e.g., from client computing devices or hosts to store or read data. The storage processor may then translate these commands to storage operations directed to one or more storage devices.

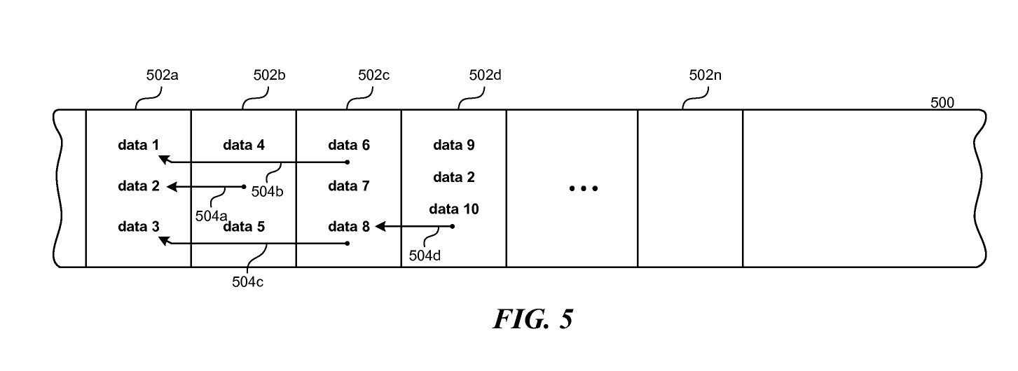

FIG. 5 is a partially schematic diagram illustrating a portion of a media element 500, e.g., a tape or tape cartridge, to store deduplicated data. A media element 500, e.g., a tape or tape cartridge, can be partitioned into N segments or partitions. A deduplication process may be applied to data stored in a specified number of segments or partitions. This specified number of segments or partitions, K, can be referred to as a “window.” In the example illustrated in FIG. 5, deduplication is applied to a three-segment window, meaning that any one segment may contain references to the previous three segments. Segment 502a stores data 1, data 2, and data 3. Segment 502 stores data 4, a reference 504a to data 2, and data 5. Segment 502c stores data 6, a reference 504b to data 2, data 7, data 8, and a reference 504c to data 3. Segment 502d stores data 9, data 2, data 10, and a reference 504d to data 8. Because segment 502d is outside of three segments from 502a, and a value of three is specified for the number of windows (e.g., K=3), data 2 is duplicated in 502d even though it was previously stored in segment 502a. Thus, when reading data sequentially from the media element, the shoeshine effect may be avoided because the media element does not have to be rewound more than K segments or partitions. As an example, a cache may store up to three segments of data and so a tape cartridge may not need to be rewound. By reducing the shoeshine effect, latency can be reduced and throughput can be increased.

Although FIG. 5 illustrates a representation whose contents and organization are designed to make them more comprehensible by a human reader, those skilled in the art will appreciate that actual data structures used by the facility to store this information may differ from what is illustrated, in that they, for example, may be organized in a different manner; may contain more or less information than shown; may be compressed and/or encrypted; etc.

One skilled in the art would understand that window deduplication may also apply to data stored on hard disk drives, e.g., wherein a window can be specified in terms of adjacent or nearby tracks, sectors, platters, hard disk drives stored in a common RAID group, etc. By applying window deduplication to data stored on hard disk drives, the technology can respond to SLOs by reducing reconstruction of deduplicated data, but at the expense of storage space.

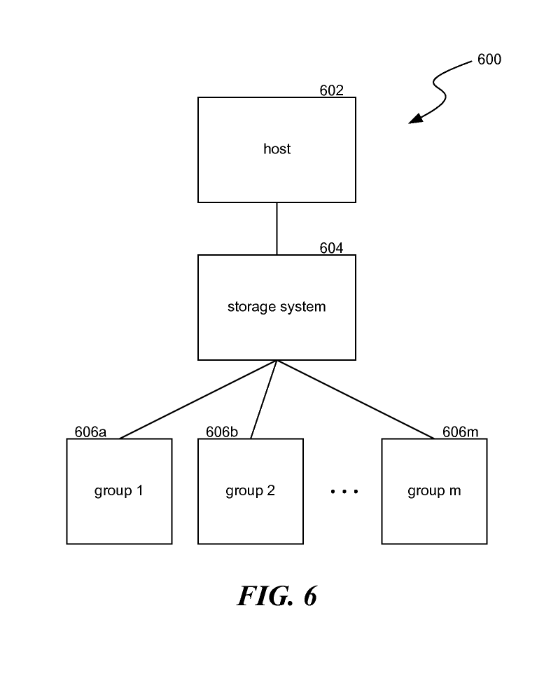

FIG. 6 is a block diagram illustrating a grouping 600 of media elements consistent with various embodiments. The environment 600 can include a host 602, a storage system 604, and one or more groups of media storage devices or media elements 606a, 606b, and 606m. The media groups can be, e.g., tape plexes. When the storage system receives storage requests, it can direct the storage requests to one or more of the media groups.

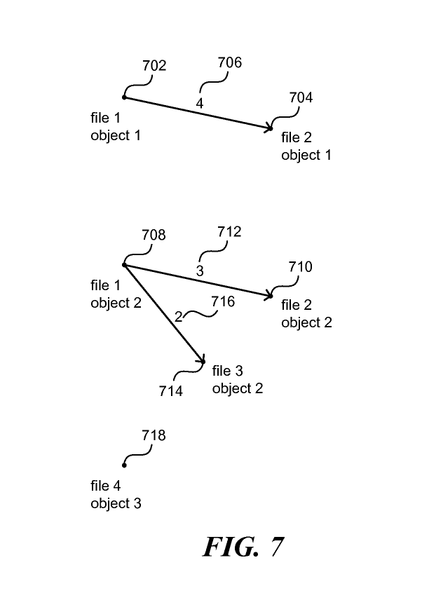

FIG. 7 is a directed acyclic graph illustrating identification of cliques. A clique is a grouping of related data. A node (or “vertex”) 702 corresponds to hash value 2 of file 1. A hash value can correspond to a portion of file 1. The storage system may store correspondences between hash values and one or more locations where corresponding data is stored. As previously discussed, although files are illustrated and discussed, the technology can also be applied to object based filesystems that store objects instead of or in addition to files. A node 704 corresponds to hash value 2 of file 2. The edge from node 702 to node 704 has a weight 706 of 4. This weight can indicate that file 2 has four references to hash value 1 of file 1. A node 708 corresponds to hash value 2 of file 1. A node 710 corresponds to hash value 2 of file 2. A node 714 corresponds to hash value 2 of file 3. The edge from node 708 to node 710 has a weight 712 of 3, meaning that hash value 2 is identical to three portions of file 2 and so has three references. The edge from node 708 to node 714 has a weight 716 of 2. Node 718 corresponds to hash value 3 of file 4. The three different or disconnected graphs each represent a “clique.” Each clique can be stored on a different media element because reading a file does not require reading data from a different clique, e.g., during reading of deduplicated data.

Although directed acyclic graphs with weighted edges are illustrated and described herein, one skilled in the art would recognize that other techniques can also be employed to determine cliques, e.g., transitive closures, strongly connected components, and/or other graph-vertex connecting techniques.

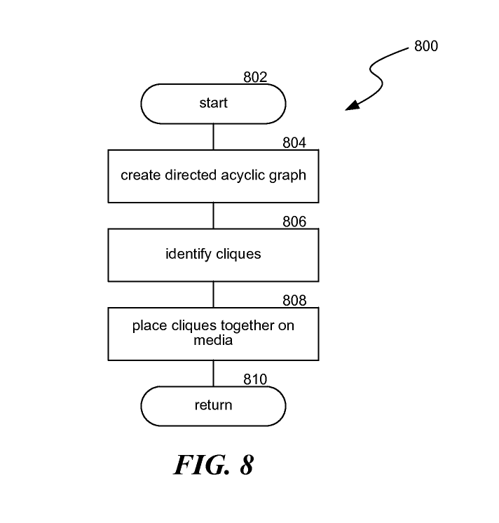

FIG. 8 is a flow diagram illustrating a routine invoked by the disclosed technology in various embodiments to group objects for storage in media elements based on an analysis of a directed acyclic graph. The routine 800 begins at block 802. At block 804, the routine creates a directed acyclic graph. The routine 800 can create the directed acyclic graph by analyzing, e.g., prior to storage to media elements, how data is duplicated. At block 806, the routine identifies cliques within the data. A clique corresponds to connections in the directed acyclic graph. In various embodiments, the directed acyclic graph can be pruned, e.g., to remove edges with low weights. At block 808, the routine identifies cliques that should be placed together in the same media element. As an example, using the directed acyclic graphs of FIG. 7, the clique corresponding to nodes 702 and 704 may be placed on the same media element. On the other hand, the data corresponding to node 718 may be placed on a different media element because no data is commonly referenced by the two cliques. At block 810, the routine returns. By placing cliques on the same media element, latency can be reduced.

Based on their experimentation, the inventors have found that with an average size of two megabytes per object, percentage of data deduplication as compared to total data stored increases as the number of media elements in groups (e.g., tape cartridges per tape plex) increases, but plateaus at between approximately 16 and 32. Thus, an optimal number of data elements can be selected based on desired SLOs. As an example, a table can be stored with a suggested number of media elements per group as a function of various SLOs. Then, when a particular SLO is specified, the technology can identify and employ the corresponding number of media elements per group.

The inventors have also found similar results with replicas. For example, if three replicas are desired, percentage deduplication increases and then plateaus at between approximately 16 and 32 tape cartridges per tape plex.

Using the various features described above, the technology is capable of receiving a service level objective, receiving data to be stored at the storage system, computing an amount of deduplication to apply to the received data responsive to the service level objective, deduplicating the data to the computed amount; and storing the deduplicated data. As an example, the technology may determine that a high amount of deduplication can be applied responsive to some SLOs, but that a lower amount of deduplication can be applied responsive to other SLOs. The data can be stored or subsequently read in a manner that corresponds to the SLOs.

The technology described above can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the technology may be stored on a computer-readable storage medium and may be executed by one or more general-purpose or special-purpose programmable microprocessors. A “computer-readable storage medium”, as the term is used herein, includes any mechanism that can store information in a form accessible by a computing device (e.g., a computer, network device, cellular phone, personal digital assistant (PDA), manufacturing tool, any device with one or more processors, etc.). For example, a computer-readable storage medium can include recordable/non-recordable media (e.g., read-only memory (ROM); random access memory (RAM); magnetic disk storage media; optical storage media; flash memory devices; etc.), etc.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a data storage system, comprising:
receiving a service level objective (SLO);
receiving data to be stored at the data storage system;
computing an amount of deduplication to apply to the received data responsive to the SLO;
deduplicating the data to the computed amount; and
storing the deduplicated data.

2. The method of claim 1, wherein the SLO specifies at least one of a latency or a throughput.

3. The method of claim 1, wherein the computing comprises identifying a window of a set of partitions and deduplicating data within the identified window.

4. The method of claim 3, wherein a data and a first reference to the data is stored in a first window, and a copy of the data and a second reference to the copy of the data is stored in the second window, wherein the first and second windows are both stored on a common media element.

5. The method of claim 1, further comprising storing a replica after storing the deduplicated data, wherein the replica does not have a reference to data stored as part of the deduplicated data.

6. The method of claim 1, further comprising computing based on the received SLO a number of media elements to include in each group of media elements.

7. The method of claim 6, further comprising deduplicating data within each group of media elements but not across groups of media elements.

8. The method of claim 7, wherein deduplicated data is stored in a first group of media elements and a replica of the deduplicated data is stored in a second group of media elements.

9. The method of claim 1, further comprising computing at least two cliques wherein data in a second clique does not reference data in a first clique.

10. The method of claim 9, further comprising storing the data corresponding to the first clique in a first media element and storing data corresponding to the second clique in a second media element.

11. The method of claim 9, wherein computing a clique comprises:
creating an directed acyclic graph, wherein each node of the graph corresponds to either data or a reference to the data and each edge between each node has associated therewith a weight indicating a count of a number of times the data is referenced.

12. A computer-readable storage medium comprising computer-executable instructions, comprising:
instructions for receiving a service level objective (SLO);
instructions for receiving data to be stored at a data storage system;
instructions for computing an amount of deduplication to apply to the received data responsive to the SLO;
instructions for deduplicating the data to the computed amount; and
instructions for storing the deduplicated data.

13. The computer-readable medium of claim 12, wherein a first portion of the received data is stored on a first media element and a second portion of the received data is stored on a second media element, and the instructions for deduplicating deduplicate the two portions of the received data separately so that the deduplicated data stored on either media element does not reference the deduplicated data stored on the other media element.

14. The computer-readable medium of claim 12, further comprising:
instructions for storing at a cache volume metadata corresponding to the stored deduplicated data.

15. The computer-readable medium of claim 12, further comprising instructions for creating a replica of the stored deduplicated data.

16. The computer-readable medium of claim 15, wherein the deduplicated data and the replica are stored on two different media elements.

17. A system, comprising:
a data storage system configured to store and retrieve data;
a service level objective (SLO) processor component configured to receive and process a SLO;
a media layout processor component configured to store data to a media element according to a specified media layout and read the stored data from the media element; and
a deduplication engine component configured to deduplicate data responsive to the received SLO.

18. The system of claim 18, wherein the media element is a tape cartridge.

19. The system of claim 18 wherein the media element is a high density data storage.

20. The system of claim 18, wherein the data storage system is a low speed data storage system.
